(19) United States
(12) Patent Application Publication
(10) Pub. No.: US 2009/0217705 A1
(43) Pub. Date: Sep. 3, 2009

(54) Temperature control of glass fusion by electromagnetic radiation

(76) Inventors: Andrey V. Filippov, Painted Post, NY (US); Allan Mark Fredholm, Hericy (FR); Jacob George, Horseheads, NY (US); Hilary Tony Godard, Lindley, NY (US); Clinton Damon Osterhout, Beaver Dams, NY (US); Gary Graham Squier, Elmira, NY (US)

Correspondence Address: CORNING INCORPORATED, SP-TI-3-1, CORNING, NY, 14831, US

(21) Appl. No.: 12/150,484

(22) Filed: Apr. 29, 2008

Related U.S. Application Data
(60) Provisional application No. 61/067,671, filed on Feb. 29, 2008.

(51) Int. Cl. C03B 18/02; C03B 5/26

(52) U.S. Cl. 65/99.1; 65/324

(57) ABSTRACT

Disclosed are systems and methods for forming glass sheets. Methods and systems are provided that comprise a refractory body configured to receive glass-based material and means for transmitting energy to selectively heat at least a portion of the refractory body through the glass-based material. In one aspect, the energy transmitted is of a selected frequency that is not fully absorbed by the glass-based material and is at least partially absorbed by the refractory body. The energy can be transmitted by a laser beam array, a scanning laser beam, a microwave generator, a radio frequency generator, or other means.

### RELATED APPLICATIONS

This application claims the benefit of U.S. Provisional Application No. 61/067,671, filed Feb. 29, 2008, entitled “Temperature Control of Glass Fusion by Electromagnetic Radiation.’

### TECHNICAL FIELD

The present invention relates to systems and methods for forming glass sheets. More specifically, systems and methods are provided for thermally controlling delivery systems utilized in the glass sheet forming process.

### BACKGROUND

Recently, significant attention has been focused on the need for flat glass sheets to be used in various applications, including LCD applications. Efforts have been made to minimize imperfections and/or defects in the glass sheets. Devitrification (crystal growth in the glass) is a common problem that affects the quality of glass sheets.

Conventional means for forming glass sheets include down-draw fusion (such as with use of an isopipe), the float process, rolling, etc. In each of these processes, molten glass-based material generally flows over a refractory body in the process of forming glass sheets. However, the liquidus viscosity of the glass-based material can limit the composition range of conventional fusion formable glasses. Conventional fusion formable glasses for LCD have liquidus viscosities greater than about 500,000 poise (and can be closer to 1,000,000 poise for 2000-series glasses). Generally, glass-based material with a liquidus viscosity less than 500,000 poise cannot currently be used to form high-quality glass-sheets due to the devitrification that takes place during the manufacturing process.

“Liquidus” has two components, namely the onset of nucleation and crystal growth rate. Nucleation can occur on the refractory surface, at the refractory-glass interface (heterogeneous nucleation) and the nucleation behavior is mainly governed by the surface roughness and local composition changes at the interface. Homogeneous nucleation (in the bulk glass, rather than at the interface) is generally a function of supercooling, the delta-T below the liquidus, up until the point at which the viscosity is sufficiently high that atoms cannot move to form nuclei. Crystal growth rate is generally at a maximum just below the liquidus temperature and gradually drops off as atomic mobility is reduced.

Another crystallization issue, although not strictly glass devitrification, is secondary zircon. Glass sheets that are manufactured using refractory bodies comprising zircon can be susceptible to this problem. Zircon or zirconia that dissolves in the glass at the high temperature stages of the manufacturing process can precipitate out in the lower temperature parts of the process in the form of small zircon needles, which can be incorporated into the glass sheet as defects. This process can occur with any refractory composition that has reduced solubility in the glass at lower temperatures and is not necessarily limited to zircon compositions.

Thus, there is a need in the art for systems and methods for forming glass sheets by thermally controlling the glass delivery system while minimizing devitrification and secondary zircon effects in the glass during the forming process.

### SUMMARY

The present invention provides a systems and methods for forming glass sheets. More specifically, systems are provided that comprise a refractory body configured to receive glass-based material, such as but not limited to molten glass. The systems further comprise means for transmitting energy to selectively heat at least a portion of the refractory body through the glass-based material. In one aspect, the energy transmitted is of a selected frequency that is not fully absorbed by the glass-based material and is at least partially absorbed by the refractory body.

In use, methods are provided that comprise providing a refractory body configured to receive glass-based material and transmitting energy to at least a portion of the refractory body through the glass-based material to heat at least the portion of the refractory body.

Additional embodiments of the invention will be set forth, in part, in the detailed description, and any claims which follow, and in part will be derived from the detailed description, or can be learned by practice of the invention. It is to be understood that both the foregoing general description and the following detailed description are exemplary and explanatory only and are not restrictive of the invention as disclosed and/or as claimed.

### BRIEF DESCRIPTION OF THE DRAWINGS

FIG. 1 illustrates an exemplary system for rolling sheet glass.

FIG. 2 illustrates an exemplary system for forming sheet glass using a float process.

FIG. 3 illustrates an exemplary system having an isopipe for forming sheet glass using a down-draw fusion process.

FIG. 4 illustrates an exemplary system comprising stray fields of RF at 40 MHz configured to heat the root refractory of an isopipe through molten glass flowing over the walls of the isopipe, according to one aspect of the invention.

FIG. 5 illustrates an exemplary system comprising parallel plate RF at 40 MHz configured to heat the root refractory of an isopipe through molten glass flowing over the walls of the isopipe, according to another aspect of the present invention.

FIG. 6 illustrates an exemplary system comprising microwave generators configured to heat the root refractory of an isopipe through molten glass flowing over the walls of the isopipe, according to one aspect of the invention.

FIG. 7 illustrates an exemplary overflow down-draw fusion system for forming sheet glass comprising an isopipe having a root portion and a laser array for heating the root refractory through molten glass (not shown) flowing over the sides of the isopipe.

FIG. 8 illustrates an exemplary overflow down-draw fusion system for forming sheet glass comprising an isopipe having a root portion and a scanning laser for heating the root refractory through molten glass (not shown) flowing over the sides of the isopipe.

FIG. 9 is a schematic diagram of an experimental set-up at 2450 MHz and 900° C. comprising similar volumes of EAGLE²⁰⁰⁰F glass and zircon material in a hybrid furnace using both MoSi₂ resistance heating elements and microwave or RF energy, according to one aspect of the invention.

FIG. 10 illustrates the results of an experiment at 2450 MHz and 900° C. using similar volumes of EAGLE²⁰⁰⁰F glass and zircon material in the experimental set-up of FIG. 8.

FIG. 11 is a graph of the Differential Dielectric Constant (∈′) of zircon material relative to EAGLE²⁰⁰⁰F glass as a function of frequency and temperature.

FIG. 12 is a graph of the Differential Dielectric Loss (∈″) of zircon material relative to EAGLE²⁰⁰⁰F glass as a function of frequency and temperature.

FIG. 13 illustrates the half-power penetration depth of zircon material and EAGLE²⁰⁰⁰F glass as a function of frequency and temperature.

FIG. 14 illustrates the loss tangent of zircon material and EAGLE²⁰⁰⁰F glass as a function of frequency and temperature.

### DETAILED DESCRIPTION

The following description of the invention is provided as an enabling teaching of the invention in its best, currently known embodiment. To this end, those skilled in the relevant art will recognize and appreciate that many changes can be made to the various embodiments of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to an isopipe includes embodiments having two or more such isopipes unless the context clearly indicates otherwise.

As used herein, the term “zircon material,” unless clearly specified to the contrary, is intended to refer to a zircon composition comprising zircon (zirconium silicate). A zircon material, according to various aspects, can be suitable for use in forming a refractory ceramic body, such as, for example, an isopipe. A zircon material, if present, can be provided in any suitable form, such as, for example, a solid or a powder.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As briefly summarized above, the present invention provides systems and methods for forming glass sheets. In order to minimize defects from developing in the glass, such as by devitrification or secondary zircon deposition, the systems and methods are provided for controlling the thermal characteristics of glass delivery systems used in the sheet-forming process. As will be described further below, by maintaining the delivery system at a sufficiently high temperature and allowing rapid cooling of glass as it flows downstream from the delivery system. By rapidly cooling the glass, the time that the glass spends in the high growth rate temperature zone of crystallization is minimized. Similarly, by heating the delivery system and minimizing thermal gradients throughout the delivery system, deposition of zircon can be controlled, such as, for example, a zircon material.

In one aspect, the system comprises a refractory body configured to receive glass-based material. The glass-based material can be molten glass, in one aspect. The refractory body has a distal end portion from which the glass-based material passes downstream. According to various aspects, the refractory body comprises a zircon refractory material.

With respect to FIG. 1, the refractory body in one aspect can be used in a rolling process for forming glass sheets. In this aspect, the refractory body 107 is sloped downward with the distal end portion lower than an opposing proximal end portion of the refractory body. As the glass-based material 111 flows downstream off of the distal end portion, it is pulled by at least one pair of rollers 115 to form a glass sheet.

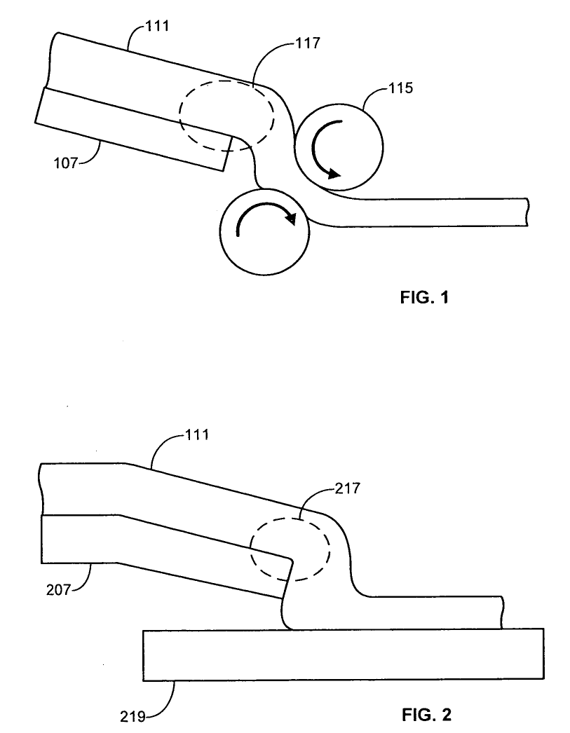

Optionally, the refractory body can be used in a float process for forming glass sheets. As illustrated in FIG. 2, at least a portion of the refractory body 207 is sloped downward with the distal end portion lower than at least a portion of the refractory body. As the molten glass-based material 111 flows downstream off of the distal end portion, it is delivered onto a bath 219 of liquid metal (such as tin).

In yet another aspect, an isopipe 301 having a refractory body 307 can be used to form glass sheets through a down-draw fusion process, such as shown in FIG. 3. The isopipe can comprise an upper portion that defines a trough 305 for receiving the molten glass-based material 111 via a supply pipe 303. The isopipe comprises an opposing lower portion that tapers toward a root 309 of the isopipe. Thus, the distal end portion of the refractory body comprises the root. The molten glass-based material 111 is received in the trough and overflows the top of the trough on both sides, thus forming two sheets of glass that flow downward and then inward along the outer surfaces of the isopipe. The two sheets meet at the root 309 of the isopipe, where they fuse together into a single sheet. The single sheet can then be fed to drawing equipment (as represented by flow arrows 313) such as rollers, which controls the thickness of the sheet by the rate at which the sheet is drawn away from the root.

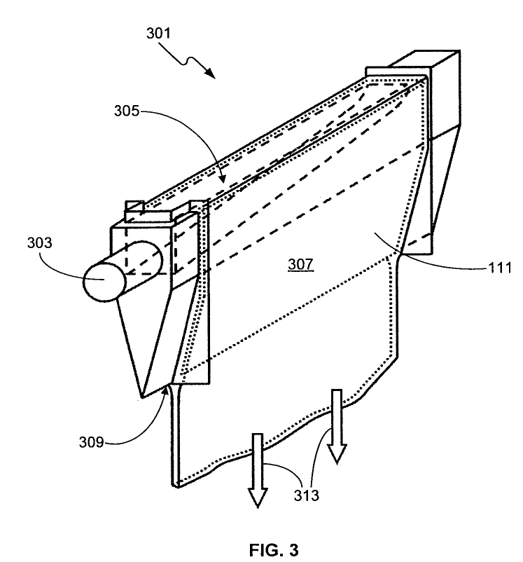

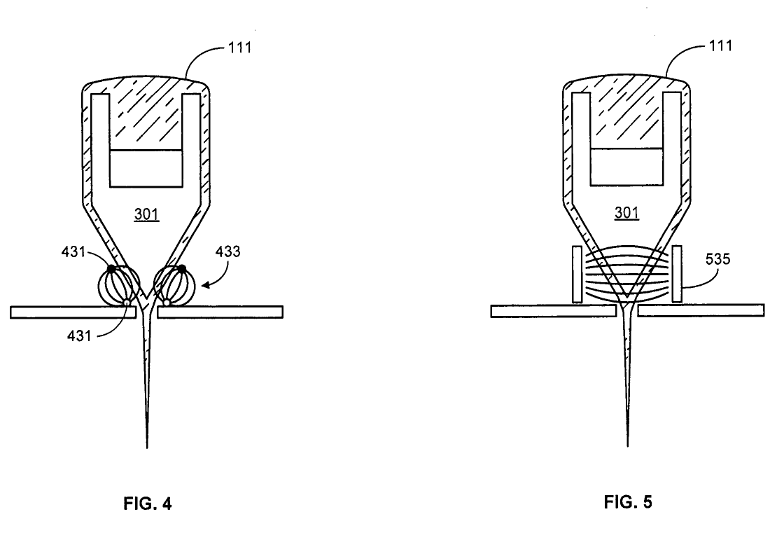

In a further aspect, the system comprises means for transmitting energy to selectively heat portions of the distal end portion through the glass-based material. For example, FIGS. 1 and 2 show energy application areas (117 and 217, respectively) proximate the point at which the molten glass separates from the respective refractory body. Similarly, energy transmission means can be configured to heat an isopipe proximate the root portion, such as shown, for example, in FIGS. 4-7. In a particular aspect, the energy transmitted is of a selected frequency that is not fully absorbed by the molten glass-based material and is at least partially absorbed by the distal end portion of the refractory body.

Various means can be used to transmit energy to selectively heat the distal end portion of a refractory body. In one aspect, a radio frequency (RF) generator can be used. A transmission system and control system can be used in combination with a radio frequency generator to direct the energy at the distal end portion of the refractory body. A transmission system can comprise two or more pairs of parallel rods that run parallel to the distal end portion of the respective refractory body to transmit the energy through the molten glass-based material. For example, with reference to FIG. 3, pairs of parallel rods 431 can be positioned on each side of the root portion of an isopipe 301 and run parallel to the root portion to generate a stray field 433 on either side of the root portion. Optionally, the transmission system can comprise parallel plates 535 running along at least part of the length of the distal end portion, such as the root portion of an isopipe 301 as shown in FIG. 5. RF can thus be transmitted relatively uniformly along the length of the distal end portion of the refractory body. In a further aspect, the plate(s) or rod(s) that generate RF can be used as heat sinks to remove heat from the glass-based material flowing along the refractory body.

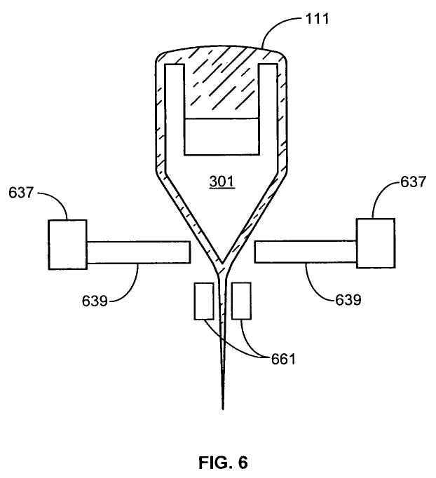

In another aspect, a microwave generator can be used to heat the distal end portion of a refractory body. The microwave generator can be coupled to a waveguide, such as a leaky waveguide, or a horn antenna, with a suitable control system. The waveguide can be positioned to direct the microwave energy at the distal end portion of the refractory body. For example, as shown in FIG. 6, microwave generators 637 coupled with waveguides 639 can be positioned on each side of the root portion of an isopipe 301. The microwave generators can direct the microwave energy at the negatively sloped portion of the isopipe proximate the root. In a further aspect, the waveguide can be at least partially metallic (such as, but not limited to, Pt-coated ceramic), and can be used as a heat sink to remove heat from the glass-based material flowing along the refractory body. Optionally, one or more heat sinks 661 can be positioned downstream of the microwave generators to remove heat from the glass-based material.

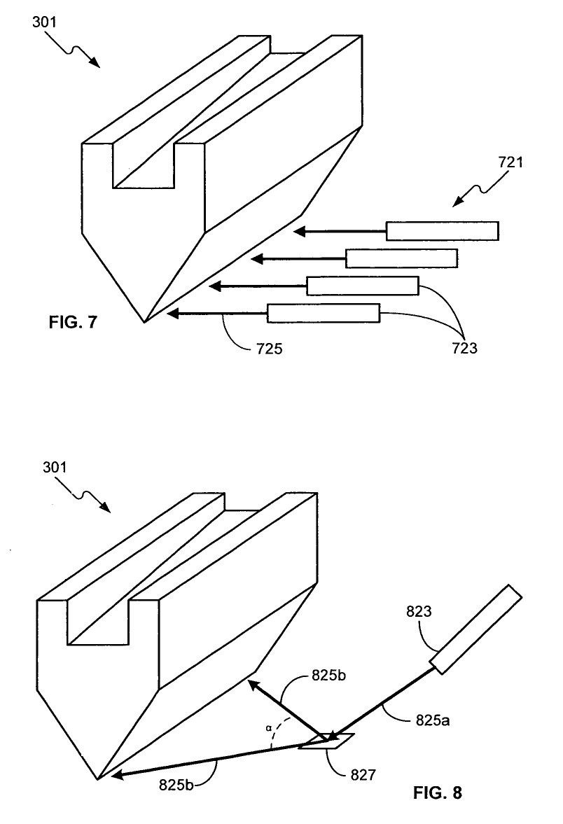

Lasers can also be used to selectively heat the distal end portion of a refractory body. For example, at least one laser beam can be directed at the distal end portion. The laser beam can have a wavelength band in the near-infrared range, such as 780-11000 nm. Optionally, the laser beam can have a wavelength band in the visible range, such as 380-780 nm. In one aspect, an array of lasers can be positioned along the length of the distal end portion. For example, with reference to FIG. 7, a laser array 721 comprising a plurality of lasers 723 can be positioned proximate the root portion of an isopipe 301 and substantially parallel to the root. The laser beams 725 generated by each of the lasers can be directed at the distal end portion of the isopipe. Although shown on only one side of the root portion, it is contemplated that a similar laser array can be positioned on the opposing side of the root portion.

As shown in FIG. 8, a scanning laser 823 can also be used to selectively heat the distal end portion of a refractory body, such as an isopipe 301. The beam(s) can be scanned along the length of the distal end portion. In one aspect, the laser can direct a laser beam 825a toward a reflective surface 827, such as a mirror, which can be selectively moved or positioned to change the directionality of the reflected beam(s) 825b. The residence time of the beam at any one spot on the refractory body would determine the local temperature rise. Pulsed near-infrared lasers such as Nd:YAG or Nd:YVO₄ can be used as scanning lasers, in one particular aspect. As shown in FIG. 8, the laser can be configured to scan at least a portion (represented by α) of the length of the distal end portion of the isopipe 301. As described with respect to FIG. 8, although the scanning laser mechanism is only shown in FIG. 4 along one side of the root portion of the isopipe, it is contemplated that a similar scanning laser mechanism can be positioned on the opposing side of the root portion.

In one aspect, the energy transmitted is in the range of about 300 to about 200,000 MHz, such as in the microwave range. Optionally, the energy transmitted can be in the range of 3 to about 300 MHz, such as in the RF range. In yet another aspect, the energy transmission means is configured to transmit energy at a frequency sufficient to heat portions of the distal end portion to a temperature that is greater than the liquidus temperature of the glass-based material flowing over the distal end portion.

According to various aspects, the system further comprises a heat sink configured to draw heat from the glass-based material. The heat sink can be positioned downstream from the distal end portion, although it is contemplated that the heat sink can be positioned anywhere along the fluid flow to selectively draw heat therefrom the glass-based material. In a particular aspect, the heat sink is positioned downstream, but proximate to the distal end portion. For example, as illustrated in FIG. 6, one or more heat sinks 661 can be positioned downstream from the root portion of an isopipe to draw heat from the glass-based material as it flows off of or is drawn off of the root. As described herein, it is contemplated that various system components can be simultaneously used as heat sinks, such as, but not limited to, RF plate(s) or rod(s), a waveguide, or other system components.

In use, methods are provided for forming glass sheets. The method in one aspect comprises providing a refractory body configured to receive glass-based material and transmitting energy to heat at least a portion of the refractory body. As described above, the refractory body can comprise a distal end portion from which the glass-based material passes downstream. Such a refractory body can include those used in the rolling process, float process, down-draw fusion process (such as an isopipe having a tapered root portion), and other known processes for making glass sheets. Optionally, methods as described herein can be used in processes for glass-forming including the gobbing process or continuous streaming of glass (tube or rod draw, etc.). The refractory body can further comprise a zircon refractory material, in one aspect.

In one aspect, the method comprises transmitting energy to at least a portion of the distal end portion of the refractory body through the glass-based material to heat this portion. The energy transmitted can be of a selected frequency that is not fully absorbed by the glass-based material and is at least partially absorbed by the distal end portion. As described above, the glass-based material has a liquidus temperature. Transmitting energy to the refractory body can comprise transmitting energy sufficient to heat the portion of the refractory body to a temperature above the liquidus temperature of the glass-based material. By maintaining at least the distal end portion of the refractory body above the liquidus temperature, the glass can be rapidly cooled to below the liquidus temperature downstream from the distal end portion and devitrification can be controlled.

The energy can be transmitted by various means, including a microwave generator, RF generator, laser array, scanning laser, or other means as described herein. The energy transmitted can be in the frequency range of about 300 to about 200,000 MHz (i.e., microwave energy) or in the frequency range of about 3 to about 300 MHz (i.e., RF energy). Optionally, lasers operating at any wavelength can be used to generate the energy, including those having discrete wavelengths or wavelength bands in the visible or near-infrared ranges.

The method can further comprise providing a heat sink at one or more predetermined positions along the fluid flow. In one aspect, the method comprises providing a heat sink downstream from the distal end portion. The heat sink can be configured to draw heat from the glass-based material. In one aspect, this can aid in the rapid cooling of the glass-based material as it separates from the refractory body proximate the distal end portion. Means can also be provided for drawing the glass-based material away from the distal end portion of the refractory body. As described above, it is contemplated that heat sinks can be positioned anywhere along the fluid flow, including upstream of the distal end portion.

It should be understood that while the present invention has been described in detail with respect to certain illustrative and specific embodiments thereof, it should not be considered limited to such, as numerous modifications are possible without departing from the broad spirit and scope of the present invention as defined in the appended claims.

### EXAMPLES

To further illustrate the principles of the present invention, the following examples are set forth so as to provide those of ordinary skill in the art with a complete disclosure and description of how the ceramic articles and methods claimed herein can be made and evaluated. They are intended to be purely exemplary of the invention and are not intended to limit the scope of what the inventors regard as their invention. Efforts have been made to ensure accuracy with respect to numbers (e.g., amounts, temperatures, etc.); however, some errors and deviations may have occurred. Unless indicated otherwise, parts are parts by weight, temperature is degrees C. or is at ambient temperature, and pressure is at or near atmospheric.

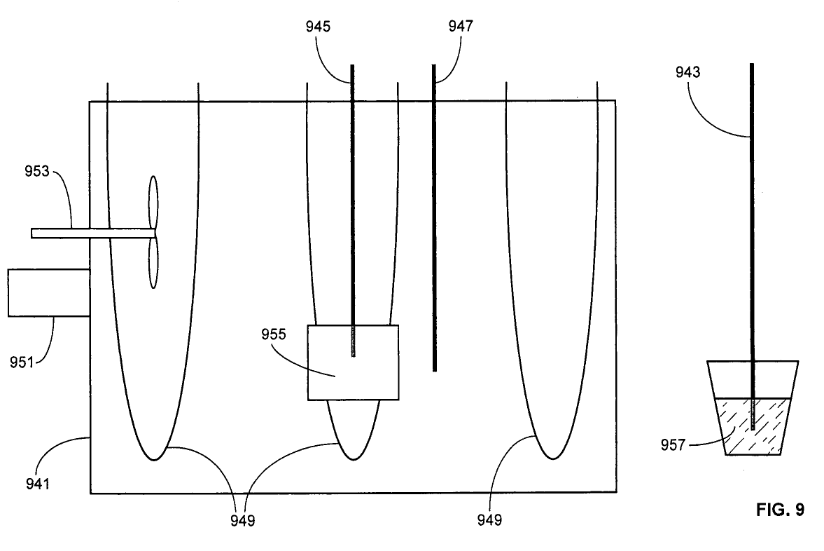

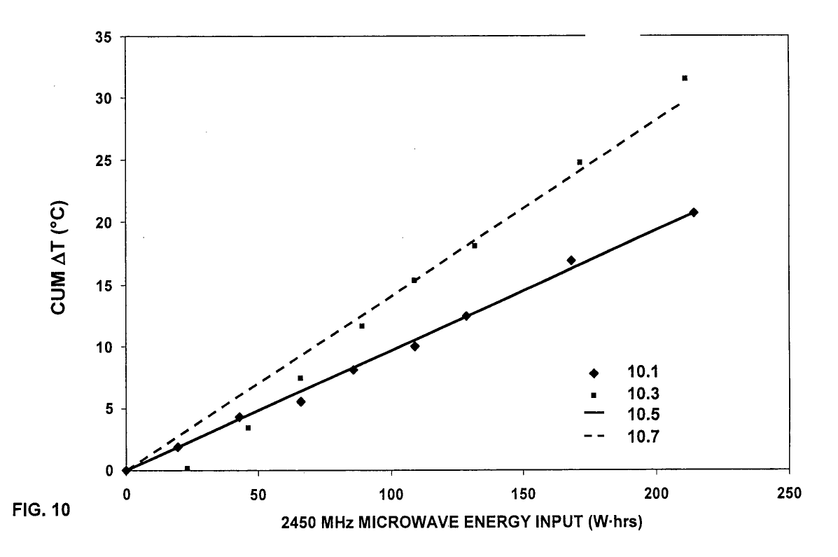

An experiment was conducted to determine various properties of similar volumes of EAGLE²⁰⁰⁰F glass and zircon material. The experimental set-up is illustrated in FIG. 9. As can be seen, the zircon material specimen 955 was placed in a hybrid furnace 941 using both MoSi₂ resistance heating elements 949 and microwave or RF generator(s) 951 to generate energy at various frequencies. A microwave or RF mode mixer 953 was also provided to achieve the effect of modulating the resonant frequencies of the modes as they move, and bring into effect modes marginally outside the spectrum. The mode mixer can also act as a secondary antenna within the furnace, coupling constantly into the existing fields and re-radiating a secondary pattern which changes with rotation. The mode mixer is used to provide enhanced uniform heating of the materials. The MoSi₂ resistance heating elements were used to bring the specimens to 900° C. An ambient thermocouple 947, a glass specimen thermocouple 943, and a zircon material specimen thermocouple 945 were provided as temperature sensors. The MoSi₂ resistance heating elements 949 were then put in manual (fixed percentage output) mode so that any incremental temperature rise in the specimens would be due to the microwave or RF heating. The glass specimen 957 and zircon material specimen 955 were run in separate sequential experiments. FIG. 10 illustrates the results of this experiment and demonstrates that temperature increase as a function of energy input is greater for the zircon material (10.3, 10.7) than for glass (10.1, 10.5), but both materials will heat up.

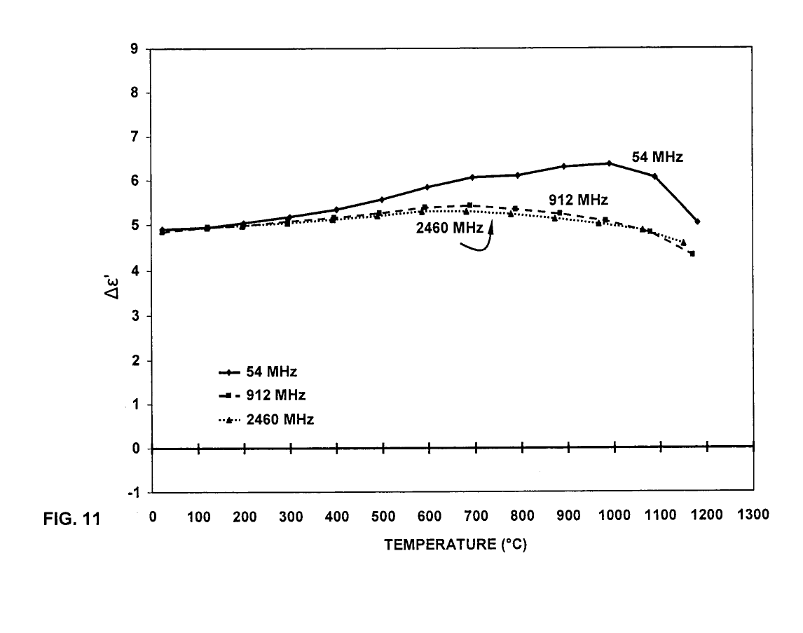

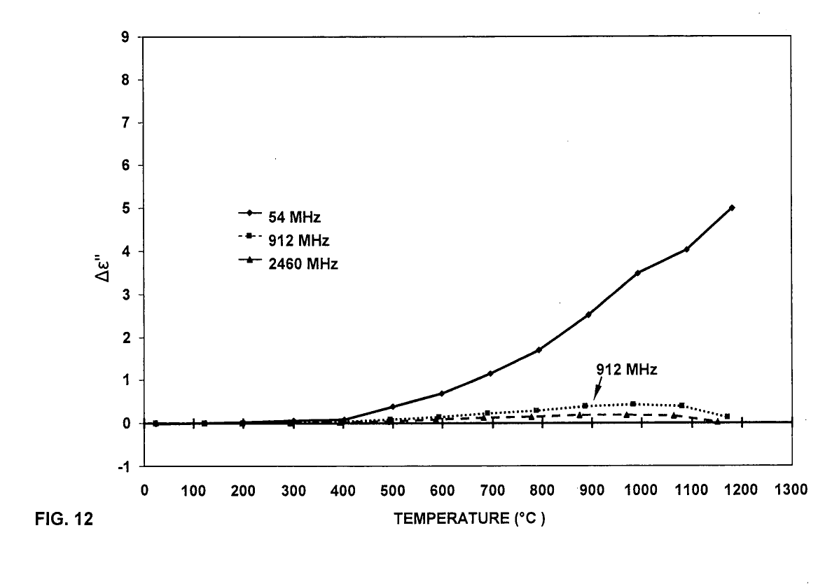

Other experiments were conducted to determine the various properties of the zircon material relative to the EAGLE²⁰⁰⁰F glass as a function of frequency and temperature. FIG. 11 illustrates the differential dielectric constant (∈′) of the zircon material relative to the EAGLE²⁰⁰⁰F glass as a function of frequency and temperature. As can be seen, the differential had the greatest increase at 54 MHz. FIG. 12 illustrates the differential dielectric loss (∈″) of the zircon material relative to the EAGLE²⁰⁰⁰F glass as a function of frequency and temperature. The differential at 912 MHz and 2460 MHz was relatively constant, with a slight increase, as temperature increased. The differential at 54 MHz, however, steadily increased as temperature increased above approximately 400° C.

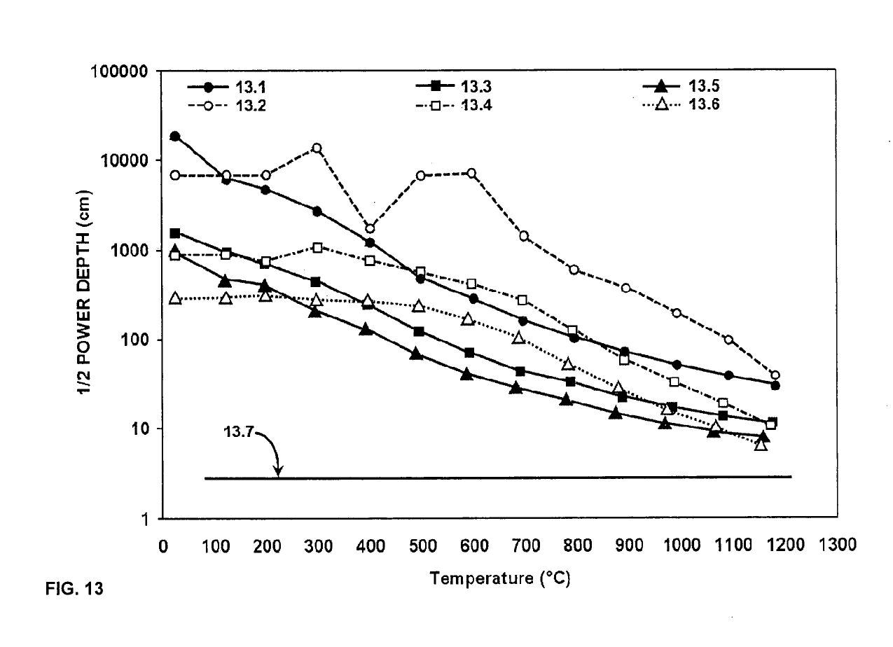

FIG. 13 illustrates the half power penetration depth in cm of zircon material relative to the EAGLE²⁰⁰⁰F glass (13.7) as a function of frequency and temperature. The frequencies tested were 54 MHz (Zircon material: 13.1, Glass: 13.2), 912 MHz (Zircon material: 13.3, Glass: 13.4), and 2460 MHz (Zircon material: 13.5, Glass: 13.6). Both materials were relatively transparent and thus energy is capable of passing through glass that is adjacent a refractory body and into the refractory body. FIG. 13 illustrates that the penetration depth is greater at 54 MHz, RF frequency, than at the two microwave frequencies (912 MHz and 2460 MHz).

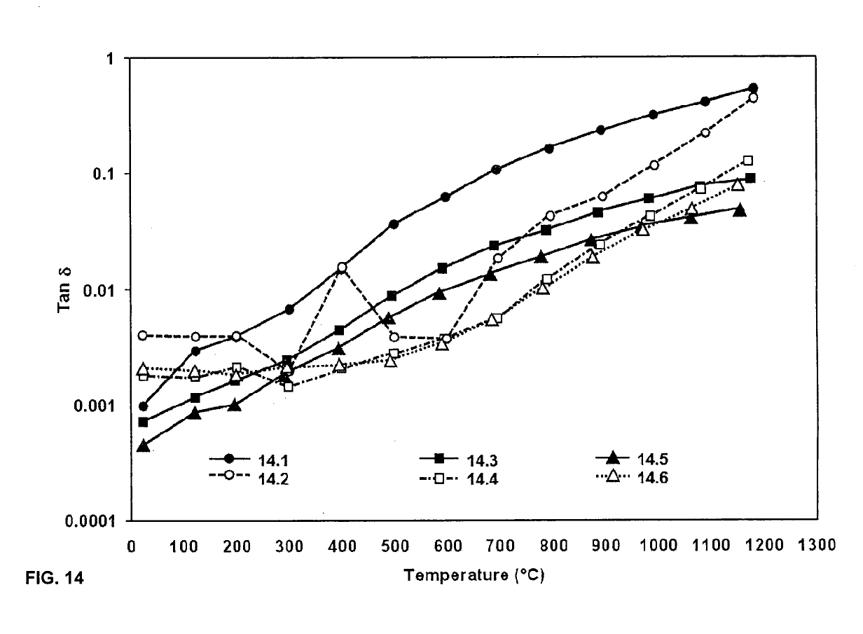

FIG. 14 illustrates the loss tangent of zircon material relative to the EAGLE²⁰⁰⁰F glass as a function of frequency and temperature. The frequencies tested were 54 MHz (Zircon material: 14.1, Glass: 14.2), 912 MHz (Zircon material: 14.3, Glass: 14.4), and 2460 MHz (Zircon material: 14.5, Glass: 14.6). Above 0.01 it is possible to heat the materials, and above 0.1 it is highly likely that the materials will heat up. Experiments at 2450 MHz and 900° C. confirmed that both materials will heat up.

It was determined that the absorption of energy by the zircon material of the isopipe increases with decreasing frequency, as can be seen in the figures. The absorption of energy by the zircon material decreases with increasing temperature. It was observed that when the absorption of the glass and zircon material are equivalent, the glass is moving and will carry part of the energy away, while the zircon material can lose the absorbed energy by thermal conductivity to the glass layer and radiation from the interface with glass. This generally results in increased heating of the isopipe as compared to the glass layer. Thus, lower cost and smaller 2450 MHz microwave equipment with relatively small waveguides can be used, rather than lower frequency equipment where the differential properties between the glass and the isopipe are larger. The waveguides can be water-cooled metal and thus can be used as heat sinks to remove additional heat from the glass.

Generally, it was found that the properties of EAGLE²⁰⁰⁰F glass and zircon material are sufficiently different at typical root temperatures, such that more energy will be absorbed by the zircon material than the glass. In this manner, the temperature of the isopipe, particularly at the isopipe-glass interface can be maintained above the temperature at which the glass devitrifies, permitting the bulk of the glass to be cooled below the liquidus temperature downstream from the isopipe.

1. A system for forming glass sheets, comprising:
a refractory body configured to receive molten glass-based material and comprising a distal end portion from which the glass-based material passes downstream;
means for transmitting energy to selectively heat portions of the distal end portion through the glass-based material, wherein the energy transmitted is of a selected frequency that is not fully absorbed by the molten glass-based material and is at least partially absorbed by the distal end portion.

2. The system of claim 1, wherein the means for transmitting energy is selected from the group consisting of a laser beam array, a scanning laser beam, a microwave generator, and a radio frequency generator.

3. The system of claim 1, wherein the energy transmitted is in the range of about 300 to about 200,000 MHz.

4. The system of claim 1, wherein the energy transmitted is in the range of about 3 to about 300 MHz.

5. The system of claim 1, wherein the refractory body comprises an isopipe and wherein the distal end portion of the refractory body comprises a tapered root portion.

6. The system of claim 1, further comprising a heat sink configured to draw heat from the glass-based material.

7. The system of claim 6, wherein the heat sink is positioned downstream from the distal end portion.

8. The system of claim 1, further comprising means for drawing the glass-based material away from the distal end portion.

9. The system of claim 1, wherein the glass-based material has a liquidus temperature, and wherein the means for transmitting energy is configured to heat the portions of the distal end portion to a temperature that is greater than the liquidus temperature of the glass-based material.

10. The system of claim 1, wherein the refractory body comprises a zircon refractory material.

11. A method for forming glass sheets, comprising:
providing a refractory body configured to receive molten glass-based material and comprising a distal end portion from which the glass-based material passes downstream;
transmitting energy to at least a first portion of the distal end portion through the glass-based material to heat at least the first portion of the distal end portion, wherein the energy transmitted is of a selected frequency that is not fully absorbed by the molten glass-based material and is at least partially absorbed by the distal end portion.

12. The method of claim 11, wherein the glass-based material has a liquidus temperature, and wherein the step of transmitting energy to at least the first portion comprises transmitting energy sufficient to heat the first portion to a temperature above the liquidus temperature of the glass-based material.

13. The method of claim 11, wherein the refractory body comprises an isopipe, wherein the distal end portion of the refractory body comprises a tapered root portion.

14. The method of claim 11, wherein the step of transmitting energy comprises transmitting microwave energy having a frequency in the range of about 300 to about 200,000 MHz.

15. The method of claim 11, wherein the step of transmitting energy comprises transmitting radio frequency energy having a frequency in the range of about 3 to about 300 MHz.

16. The method of claim 11, wherein the step of transmitting energy comprises directing at least one laser beam at the first portion of the distal end portion, wherein the laser beam has a wavelength band in the near-infrared range.

17. The method of claim 11, wherein the step of transmitting energy comprises directing at least one laser beam at the first portion of the distal end portion, wherein the laser beam has a wavelength band in the visible range.

18. The method of claim 11, further comprising providing a heat sink downstream from the distal end portion, wherein the heat sink is configured to draw heat from the glass-based material.

19. The method of claim 11, further comprising providing means for drawing the glass-based material away from the distal end portion.

20. The method of claim 11, wherein the refractory body comprises a zircon refractory material.
